(19) United States
(12) Patent Application Publication
(10) Pub. No.: US 2017/0122777 A1
(43) Pub. Date: May 4, 2017

(54) MAGNETIC POSITION DETECTION DEVICE

(71) Applicant: TDK Corporation, Tokyo (JP)

(72) Inventors: Hiroyuki Hirano, Tokyo (JP); Seiji Fukuoka, Tokyo (JP); Keiji Suzuki, Tokyo (JP); Takahiro Moriya, Tokyo (JP); Kaoru Narita, Tokyo (JP)

(21) Appl. No.: 15/317,483

(22) PCT Filed: Jan. 28, 2015
(86) PCT No.: PCT/JP2015/052296

§ 371 Date: Dec. 9, 2016

(30) Foreign Application Priority Data
Aug. 26, 2014 (JP) 2014-171072

(51) Int. Cl. G01D 5/14

(52) U.S. Cl. CPC G01D 5/14

(57) ABSTRACT

A magnetic position detection device that can detect position even if there is only one object magnet. A magnetic position detection device includes a bias magnet, a magnetic detection element, an object magnet, and a mobile object. Opposite poles of the bias magnet and of the object magnet face each other. The magnetic detection element is disposed between pole surfaces of the bias magnet and of the object magnet. The magnetic detection element is fixed to the bias magnet and has a fixed positional relationship to the bias magnet. The orientation of the magnetic field at the magnetic detection element changes in accordance with the position of the object magnet. The magnetic detection element detects the orientation of the magnetic field applied to the magnetic detection element.

### TECHNICAL FIELD

The present invention relates to a magnetic position detection device using a magnetic detection element and utilized for a position sensor and a stroke sensor, for example.

### BACKGROUND ART

In conventionally known magnetic position detection devices, four spin-valve magnetic resistance elements are arranged at the same position with respect to a magnetic pole arrangement direction of magnetic members having N-poles and S-poles alternatively magnetized.

### PRIOR ART DOCUMENT

Patent Document

### Patent Document 1: Japanese Patent No. 5013146

### Patent Document 2: Japanese Laid-Open Patent Publication No. 2006-23179

### SUMMARY OF THE INVENTION

### Problem to be Solved by the Invention

Although conventional techniques require multiple magnets to be detected (object magnets), multiple object magnets cannot be arranged in some cases due to restriction on space. Using only one object magnetic leads to a problem of a narrow detectable stroke range. Additionally, objects to be detected are limited to magnets.

The present invention was conceived in view of the situations and it is therefore a first object of the present invention to provide a magnetic position detection device capable of preferable position detection even when only one object magnet is used.

A second object of the present invention is to provide a magnetic position detection device capable of preferable position detection even when an object to be detected is a soft magnetic body.

### Means for Solving the Problem

A first aspect of the present invention is a magnetic position detection device. The magnetic position detection device comprises:

a bias magnet; an object magnet; and a magnetic detection element detecting a direction of an applied magnetic field, wherein

a movement of the object magnet relative to the bias magnet changes a magnetic field direction at a position of the magnetic detection element, and

when the bias magnet and the object magnet come closest to each other, a magnetic field generated by the object magnet is larger than a magnetic field generated by the bias magnet at the position of the magnetic detection element.

When the bias magnet is right in front of the object magnet, the same poles may face each other between the object magnet and the bias magnet.

A magnetic pole surface of the bias magnet facing toward the object magnet and a magnetic pole surface of the object magnet facing toward the bias magnet may be substantially parallel to, and the same in polarity as, each other and may be substantially parallel to a relative movement direction of the object magnet.

A magnetic pole surface of the bias magnet facing toward the object magnet and a magnetic pole surface of the object magnet facing toward the bias magnet may be substantially parallel to, and different in polarity from, each other and may be substantially parallel to a relative movement direction of the object magnet.

A magnetic pole surface of the bias magnet and a magnetic pole surface of the object magnet may be substantially parallel to each other and may be substantially perpendicular to a relative movement direction of the object magnet.

A magnetic pole surface of the bias magnet and a magnetic pole surface of the object magnet may be substantially perpendicular to each other.

A second aspect of the present invention is a magnetic position detection device. The magnetic position detection device comprises:

a bias magnet;

an object magnet facing the bias magnet such that different poles face each other; and

a magnetic detection element detecting a direction of an applied magnetic field, wherein

a movement of the object magnet relative to the bias magnet changes a magnetic field direction at a position of the magnetic detection element.

A magnetic pole surface of the object magnet may have a length related to a direction of the relative movement longer than that of a magnetic pole surface of the bias magnet.

A position of the object magnet relative to the bias magnet may be uniquely identifiable.

The magnetic detection element may be located at a position coming closer to the object magnet than the bias magnet when the bias magnet is right in front of the object magnet.

The only one object magnet may be included.

A third embodiment of the present invention is a magnetic position detection device. The magnetic position detection device comprises:

a bias magnet; a soft magnetic body; and a magnetic detection element detecting a direction of an applied magnetic field, wherein

a movement of the soft magnetic body relative to the bias magnet changes a magnetic field direction at a position of the magnetic detection element, and

a position of the soft magnetic body relative to the bias magnet is uniquely identifiable.

It is to be noted that any arbitrary combination of the above-described structural components as well as the expressions according to the present invention changed among a system and so forth are all effective as and encompassed by the present aspects.

### Effect of the Invention

The first and second aspects of the present invention can provide the magnetic position detection device capable of favorable position detection even when only one object magnet is used.

The third aspect of the present invention can provide the magnetic position detection device capable of favorable position detection even when an object to be detected is a soft magnetic body.

### BRIEF DESCRIPTION OF DRAWING

FIG. 1 is a schematic configuration diagram of a magnetic position detection device according to a first embodiment of the present invention.

FIG. 2 is a graph of an example of a relationship between a magnetic field direction (angle) at a position of a magnetic detection element 2 (detection position) and a movement amount of an object magnet 3, in the magnetic position detection device of FIG. 1.

FIGS. 3A, 3B. and 3C are explanatory views of changes in magnetic lines associated with movement of the object magnet 3 in the magnetic position detection device of FIG. 1.

FIG. 4 is a schematic configuration diagram of a magnetic position detection device according to a second embodiment of the present invention.

FIG. 5 is a schematic configuration diagram of a magnetic position detection device according to a third embodiment of the present invention.

FIG. 6 is a graph of an example of a relationship between a magnetic field direction (angle) at a position of the magnetic detection element 2 (detection position) and a movement amount of the object magnet 3, in the magnetic position detection device of FIG. 5.

FIGS. 7A, 7B, 7C, 7D, 7E, and 7F are explanatory views of changes in magnetic lines associated with movement of the object magnet 3 in the magnetic position detection device of FIG. 5.

FIGS. 8A, 8B, 8C, 8D, 8E, 8F, 8G, and 8H are explanatory views of changes in magnetic lines associated with movement of the object magnet 3 in a magnetic position detection device according to a fourth embodiment of the present invention.

FIG. 9 is a graph of an example of a relationship between a magnetic field direction (angle) at a position of the magnetic detection element 2 (detection position) and a movement amount of the object magnet 3, in the magnetic position detection device of FIGS. 8A, 8B, 8C, 8D, 8E, 8F, 8G, and 8H.

FIGS. 10A, 10B, 10C, 10D, 10E, 10F, and 10G are explanatory views of changes in magnetic lines associated with movement of the object magnet 3 in a magnetic position detection device according to a fifth embodiment of the present invention.

FIGS. 11A, 11B, 11C, 11D, 11E, 11F, and 11G are explanatory views of changes in magnetic lines associated with movement of the object magnet 3 in a magnetic position detection device according to a sixth embodiment of the present invention.

FIGS. 12A, 12B, and 12C are explanatory views of changes in magnetic lines associated with movement of a soft magnet body 5 in a magnetic position detection device according to a seventh embodiment of the present invention.

FIG. 13 is a graph of an example of a relationship between a magnetic field direction (angle) at a position of the magnetic detection element 2 (detection position) and a movement amount of the soft magnet body 5, in the magnetic position detection device of FIGS. 12A, 12B and 12C.

FIGS. 14A, 14B, and 14C are explanatory views of changes in magnetic lines associated with movement of the soft magnetic body 5 in a magnetic position detection device according to an eighth embodiment of the present invention.

FIG. 15 is a graph of an example of a relationship between a magnetic field direction (angle) at a position of the magnetic detection element 2 (detection position) and a movement amount of the soft magnetic body 5 in the magnetic position detection device of FIGS. 14A, 14B, and 14C.

### EMBODIMENT FOR CARRYING OUT THE INVENTION

Now, preferred embodiments of the present invention will be described in detail, referring to the drawings. The same or equivalent constituent elements, members and so on which are shown in the respective drawings are denoted with the same reference numerals, and overlapped descriptions are appropriately omitted. Moreover, the present invention is not limited to the embodiments, but the embodiments are only examples. All features and the combinations of the features which are described in the embodiments are not absolutely essential to the present invention.

### First Embodiment

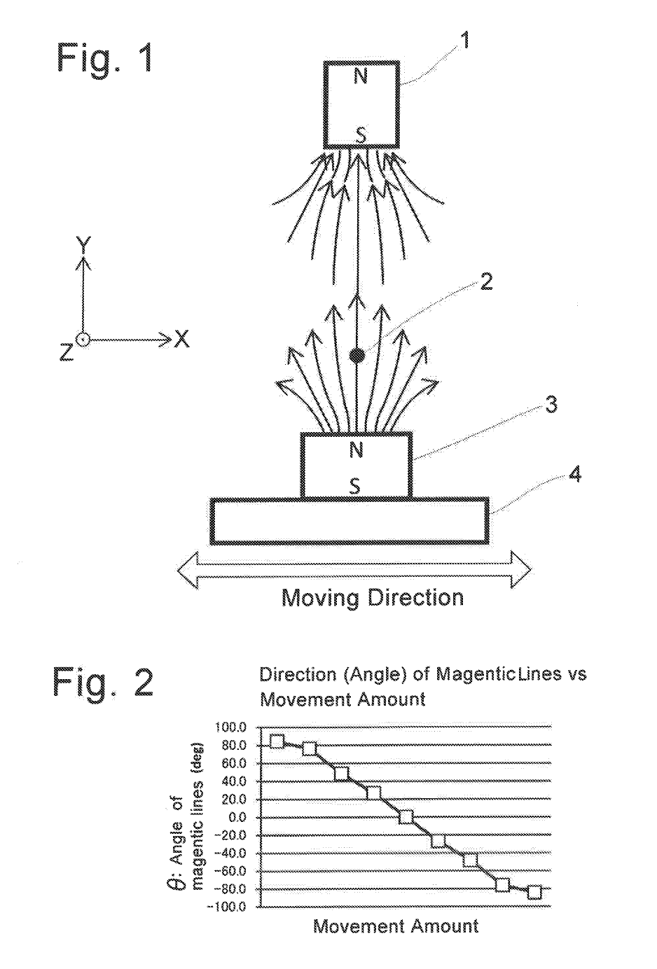

FIG. 1 is a schematic configuration diagram of a magnetic position detection device according to a first embodiment of the present invention. In FIG. 1, X-direction, Y-direction, and Z-direction are defined as three orthogonal directions. FIG. 1 also shows a portion of magnetic lines generated by a bias magnet 1 and an object magnet 3. The magnetic position detection device of this embodiment includes the bias magnet 1, a magnetic detection element 2, the object magnet 3, and a mobile object 4.

The bias magnet 1 and the object magnet 3 are preferably rare-earth magnets such as neodymium magnets and are formed into a columnar shape or a prismatic shape, for example, and arranged such that different poles face each other. In the shown example, the S-pole surface of the bias magnet 1 and the N-pole surface of the object magnet 3 face each other. The facing magnetic pole surfaces of the bias magnet 1 and the object magnet 3 are both parallel to the XZ plane. The non-facing magnetic pole surfaces of the bias magnet 1 and the object magnet 3 are also both parallel to the XZ plane. Preferably, the facing magnetic pole surface of the object magnet 3 has a length related to a relative movement direction (X-direction, or X- and Y-directions) longer than that of the facing magnetic pole surface of the bias magnet 1. Preferably, the object magnet 3 has a more flattened shape than the bias magnet 1.

The magnetic detection element 2 is disposed in front of the S-pole surface of the bias magnet 1 (the facing magnetic pole surface toward the object magnet 3). The magnetic detection element 2 is fixedly disposed relative to the bias magnet 1 so as to fix a relative positional relationship with the bias magnet 1. The X-directional position of the magnetic detection element 2 is preferably identical to the X-directional position of the center of the bias magnet 1. The magnetic detection element 2 detects a direction of a magnetic field applied thereto and is implemented by, for example, a combination of multiple Hall elements and a magnetic yoke, or a combination of multiple spin-valve magnetic resistance elements (see Patent Document 1: Japanese Patent No. 5013146 as needed). Preferably, the magnetic detection element 2 is disposed at a position located closer to the object magnet 3 than the bias magnet 1 when the bias magnet 1 is right in front of the object magnet 3 (come closest to each other) as shown in FIG. 1. Preferably, the object magnet 3 has a magnetic force stronger than the bias magnet 1. In the case of the magnetic detection element 2 capable of detecting two-component detection (XY-component detection), the bias magnet 1, the magnetic detection element 2, and the object magnet 3 preferably have the centers at the Z-directional positions made identical to each other. The object magnet 3 is fixed to the mobile object 4 and moves in the X-direction as the mobile object 4 moves. On the other hand, in the case of the magnetic detection element 2 capable of detecting three-component detection (XYZ-component detection), a two-dimensional position of the object magnet 3 can be detected in the XZ plane, and the object magnet 3 may move in the XZ plane along with the mobile object 4. The movement of the object magnet 3 changes the magnetic field direction at the position of the magnetic detection element 2.

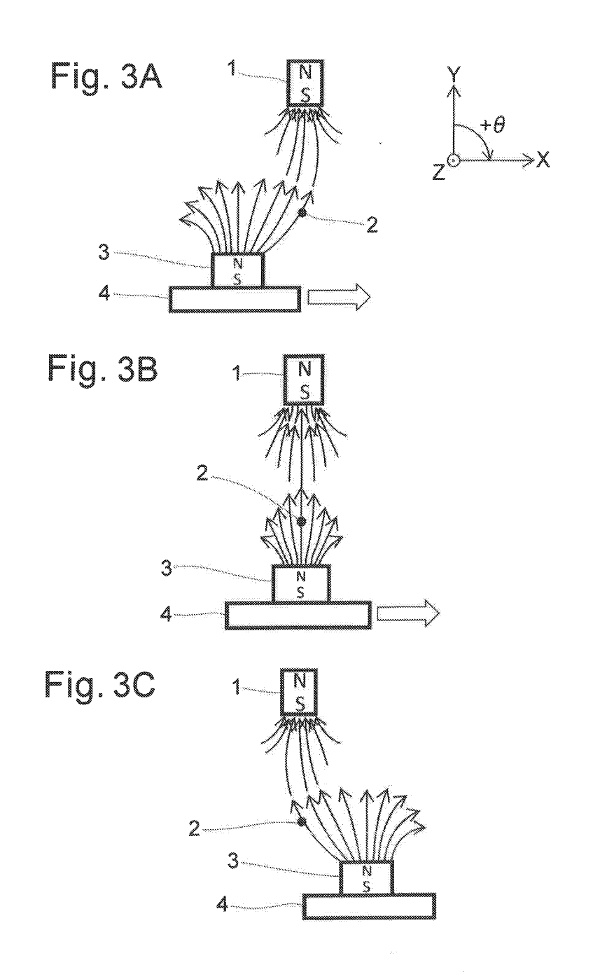

FIG. 2 is a graph of an example of a relationship between a magnetic field direction (angle) at a position of the magnetic detection element 2 (detection position) and a movement amount of the object magnet 3 in the magnetic position detection device of FIG. 1. In FIG. 2, an angle (θ) of the vertical axis is an angle in the clockwise direction starting from the +Y-direction. FIGS. 3A to 3C are explanatory views of changes in magnetic lines associated with movement of the object magnet 3 in the magnetic position detection device of FIG. 1. FIGS. 3A to 3C show a portion in the vicinity of the center of the stroke range of the object magnet 3 and, actually, as shown in FIG. 2, the magnetic field direction at the position of the magnetic detection element 2 changes in a range exceeding ±80 degrees. As shown in FIGS. 3A, 3B. and 3C, as the object magnet 3 and the mobile object 4 move rightward (in the +X-direction), the magnetic field rotates counterclockwise at the position of the magnetic detection element 2. Conversely, if the object magnet 3 and the mobile object 4 move leftward (in the −X-direction), the magnetic field rotates clockwise at the position of the magnetic detection element 2. In this way, a magnetic flux between the bias magnet 1 and the object magnet 3 has a vector changing like a pendulum at the bias magnet 1 as a supporting point in accordance with the movement of the object magnet 3 and the mobile object 4 in the ±X-directions. By detecting this vector change with the magnetic detection element 2, the position of the object magnet 3 and the mobile object 4 can be detected. As can be seen from FIG. 2, the magnetic field direction at the position of the magnetic detection element 2 changes in accordance with changes in the X-directional movement amount of the object magnet 3 and, since the X-directional movement amount of the object magnet 3 corresponds to the magnetic field direction (angle) in a one-to-one relationship, the movement amount (position) of the object magnet 3 and the mobile object 4 can be detected (uniquely identified) based on the output of the magnetic detection element 2 corresponding to the magnetic field direction.

This embodiment can produce the following effects.

(1) Since the bias magnet 1 is disposed behind the magnetic detection element 2, and the bias magnet 1 and the object magnet 3 are arranged such that different poles face each other, a detectable stroke range can be widened despite of the one object magnet 3. Therefore, even when a restriction on space exists making it unable to dispose the multiple object magnets 3, preferable position detection is enabled.

(2) Since the magnetic field at the position of the magnetic detection element 2 is strengthened by disposing the bias magnet 1, the magnetic field strength required for detection can be ensured even when the magnetic detection element 2 is more away from the object magnet 3 as compared to the case without the bias magnet 1, and a degree of freedom of layout is increased.

(3) Since the object magnet 3 is formed into a more flattened shape than the bias magnet 1 and the facing magnetic pole surface of the object magnet 3 has a length related to the movement direction made longer than that of the facing magnetic pole surface of the bias magnet 1, the magnetic flux of the object magnet 3 spreads in the X-direction and the bias magnet 1 strongly attracts the magnetic flux in the Y-direction in a narrow range. Since the magnetic detection element 2 is disposed at a position located closer to the object magnet 3 than the bias magnet 1 when the bias magnet 1 is right in front of the object magnet 3, the magnetic field rotating in accordance with the movement of the object magnet 3 can be acquired in a wide stroke range at the position of the magnetic detection element 2. Additionally, the object magnet 3 has a magnetic force stronger than the bias magnet 1, this also leads to a wider stroke range (the magnetic field direction can be changed by nearly 180 degrees at the position of the magnetic detection element 2 in accordance with the movement of the object magnet 3).

### Second Embodiment

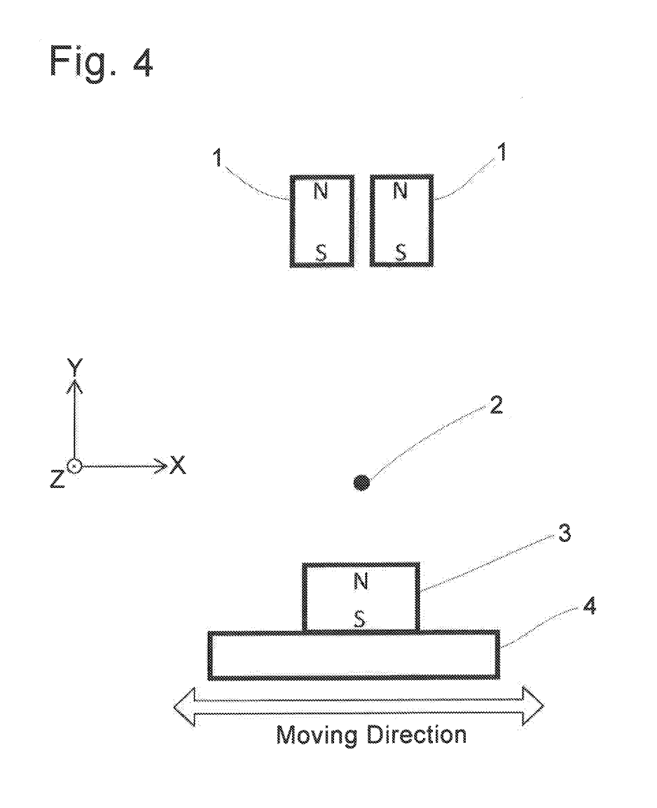

FIG. 4 is a schematic configuration diagram of a magnetic position detection device according to a second embodiment of the present invention. The magnetic position detection device of this embodiment is different from the device of the first embodiment shown in FIG. 1 etc. in that the two bias magnets 1 are included. When the two bias magnets 1 are included, the X-direction position of the magnetic detection element 2 is made identical to the center of the gap between the bias magnets 1, and the other points are the same as the case shown in FIG. 1. This embodiment can produce the same effects as the first embodiment.

### Third Embodiment

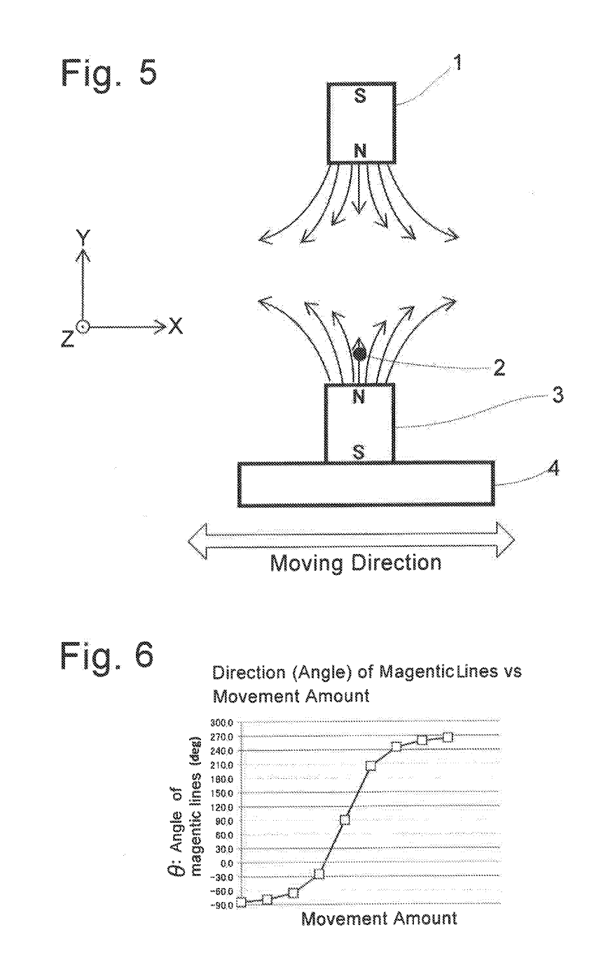

FIG. 5 is a schematic configuration diagram of a magnetic position detection device according to a third embodiment of the present invention. In FIG. 5, X-direction, Y-direction, and Z-direction are three orthogonal directions defined in the same way as FIG. 1. FIG. 5 also shows a portion of magnetic lines generated by the bias magnet 1 and the object magnet 3. In the magnetic position detection device of this embodiment, unlike the device of the first embodiment shown in FIG. 1 etc., the bias magnet 1 and the object magnet 3 are arranged such that the same poles face each other. In the shown example, the N-pole surface of the bias magnet 1 and the N-pole surface of the object magnet 3 face each other. The facing magnetic pole surfaces of the bias magnet 1 and the object magnet 3 are both parallel to the XZ plane. The non-facing magnetic pole surfaces of the bias magnet 1 and the object magnet 3 are also both parallel to the XZ plane.

The magnetic detection element 2 is disposed in front of the N-pole surface of the bias magnet 1 (the facing magnetic pole surface toward the object magnet 3). The magnetic detection element 2 is fixedly disposed relative to the bias magnet 1 so as to fix a relative positional relationship with the bias magnet 1. The X-directional position of the magnetic detection element 2 is preferably identical to the X-directional position of the center of the bias magnet 1. Preferably, the magnetic detection element 2 is disposed at a position located closer to the object magnet 3 than the bias magnet 1 when the bias magnet 1 is right in front of the object magnet 3 (come closest to each other) as shown in FIG. 5. This is because when the bias magnet 1 is right in front of the object magnet 3, the magnetic field generated by the object magnet 3 is made larger than the magnetic field generated by the bias magnet 1 at the position of the magnetic detection element 2. As a result, when the bias magnet 1 is right in front of the object magnet 3, the magnetic field direction at the position of the magnetic detection element 2 can be directed in the +Y-direction (upward) and, as described later, the magnetic field direction can be rotated by approx. 360 degrees at the position of the magnetic detection element 2 in accordance with the movement of the object magnet 3. In the case of the magnetic detection element 2 capable of detecting two-component detection (XY-component detection), the bias magnet 1, the magnetic detection element 2, and the object magnet 3 preferably have the centers at the Z-directional positions made identical to each other. The object magnet 3 is fixed to the mobile object 4 and moves in the X-direction as the mobile object 4 moves. On the other hand, in the case of the magnetic detection element 2 capable of detecting three-component detection (XYZ-component detection), a two-dimensional position of the object magnet 3 can be detected in the XZ plane, and the object magnet 3 may move in the XZ plane along with the mobile object 4. The movement of the object magnet 3 changes the magnetic field direction at the position of the magnetic detection element 2.

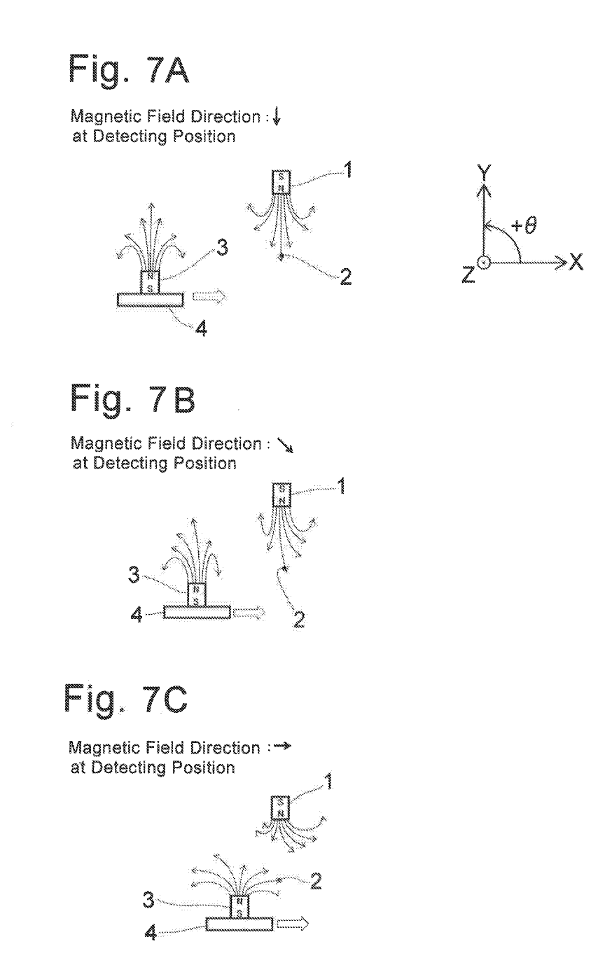

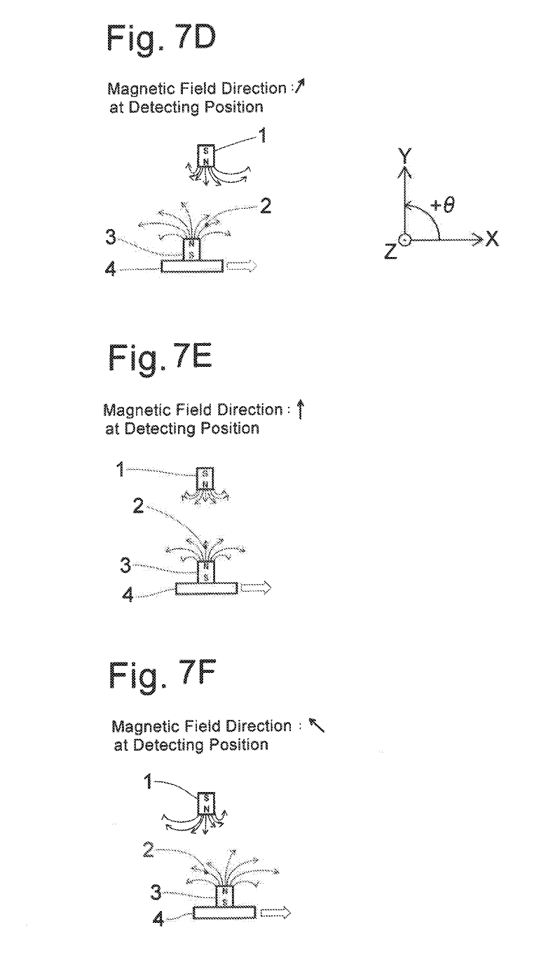

FIG. 6 is a graph of an example of a relationship between a magnetic field direction (angle) at a position of the magnetic detection element 2 (detection position) and a movement amount of the object magnet 3 in the magnetic position detection device of FIG. 5. In FIG. 6, an angle (θ) of the vertical axis is an angle in the counterclockwise direction starting from the +X-direction. FIGS. 7A to 7F are explanatory views of changes in magnetic lines associated with movement of the object magnet 3 in the magnetic position detection device of FIG. 5. FIGS. 7A to 7F show a portion of the stroke range of the object magnet 3 and, actually, as shown in FIG. 6, the magnetic field direction at the position of the magnetic detection element 2 is changed by approx. 360 degrees in accordance with relative movement of the object magnet 3. As shown in FIGS. 7A, 7B, 7C, 7D, 7E, and 7F, as the object magnet 3 and the mobile object 4 move rightward (in the +X-direction), the magnetic field rotates counterclockwise at the position of the magnetic detection element 2. Conversely, if the object magnet 3 and the mobile object 4 move leftward (in the −X-direction), the magnetic field rotates clockwise at the position of the magnetic detection element 2. In this way, a magnetic flux between the bias magnet 1 and the object magnet 3 has a vector changing in a rotating manner around the position of the magnetic detection element 2 in accordance with the movement of the object magnet 3 and the mobile object 4 in the ±X-directions. By detecting this vector change with the magnetic detection element 2, the position of the object magnet 3 and the mobile object 4 can be detected. As can be seen from FIG. 6, the magnetic field direction at the position of the magnetic detection element 2 changes in accordance with changes in the X-directional movement amount of the object magnet 3 and, since the X-directional movement amount of the object magnet 3 corresponds to the magnetic field direction (angle) in a one-to-one relationship, the movement amount (position) of the object magnet 3 and the mobile object 4 can be detected (uniquely identified) based on the output of the magnetic detection element 2 corresponding to the magnetic field direction.

According to this embodiment, since the magnetic field direction at the position of the magnetic detection element 2 is changed by approx. 360 degrees in accordance with the relative movement of the object magnet 3, a wider stroke range can be ensured as compared to the first embodiment in which the magnetic field direction is changed by 180 degrees or less.

### Fourth Embodiment

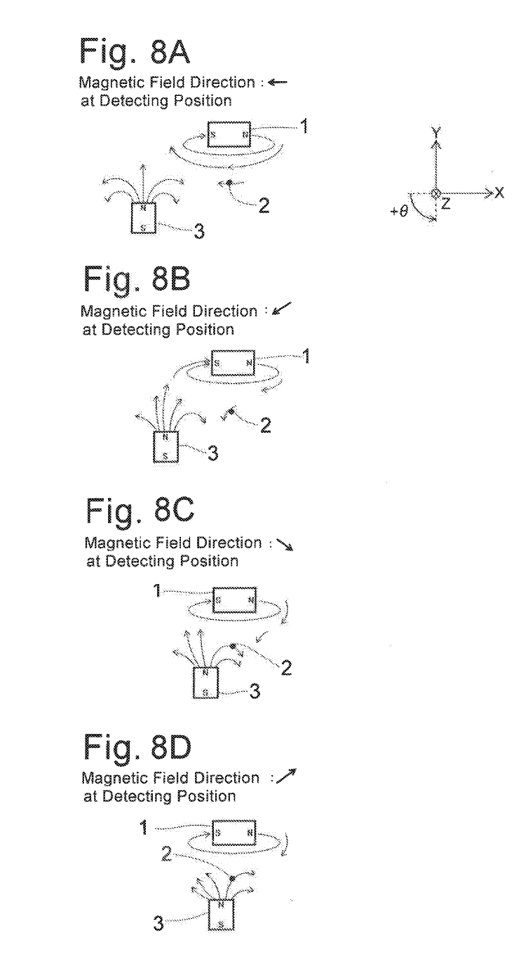

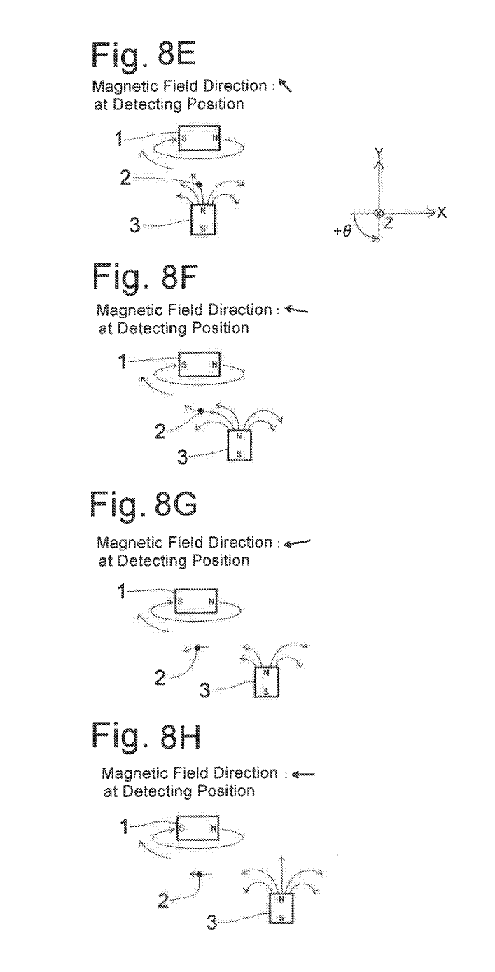

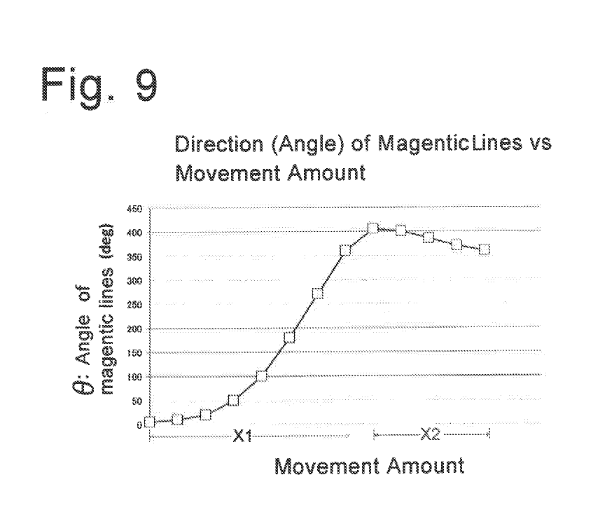

FIGS. 8A, 8B, 8C, 8D, 8E, 8F, 8G, and 8H are explanatory views of changes in magnetic lines associated with movement of the object magnet 3 in a magnetic position detection device according to a fourth embodiment of the present invention. In FIGS. 8A to 8H, a mobile object having the object magnet 3 fixed thereto and moving along with the object magnet 3 is not shown. FIG. 9 is a graph of an example of a relationship between a magnetic field direction (angle) at a position of the magnetic detection element 2 (detection position) and a movement amount of the object magnet 3 in the magnetic position detection device of FIGS. 8A, 8B, 8C, 8D, 8E, 8F, 8G, and 8H. In FIG. 9, an angle (θ) of the vertical axis is an angle in the counterclockwise direction starting from the −X-direction.

In the magnetic position detection device of this embodiment, unlike the device of the first embodiment shown in FIG. 1 etc., the magnetic pole surfaces of the bias magnet 1 and the magnetic pole surfaces of the object magnet 3 are perpendicular to each other. In this embodiment, the magnetic pole surfaces of the bias magnet 1 are parallel to the YZ plane, and the magnetic pole surfaces of the object magnet 3 are parallel to the XZ plane. The magnetic detection element 2 is disposed in front of a non-magnetic pole surface of the bias magnet 1 facing toward the object magnet 3. The magnetic detection element 2 is fixedly disposed relative to the bias magnet 1 so as to fix a relative positional relationship with the bias magnet 1. The X-directional position of the magnetic detection element 2 is preferably identical to the X-directional position of the center of the bias magnet 1. Preferably, the magnetic detection element 2 is disposed at a position located closer to the object magnet 3 than the bias magnet 1 when the bias magnet 1 is right in front of the object magnet 3 (come closest to each other). In the case of the magnetic detection element 2 capable of detecting two-component detection (XY-component detection), the bias magnet 1, the magnetic detection element 2, and the object magnet 3 preferably have the centers at the Z-directional positions made identical to each other. On the other hand, in the case of the magnetic detection element 2 capable of detecting three-component detection (XYZ-component detection), a two-dimensional position of the object magnet 3 can be detected in the XZ plane, and the object magnet 3 may move in the XZ plane. The movement of the object magnet 3 changes the magnetic field direction at the position of the magnetic detection element 2.

In the range shown in FIGS. 8A, 8B, 8C, 8D, 8E, 8F, 8G, and 8H, as the object magnet 3 moves rightward (in the +X-direction), the magnetic field rotates counterclockwise at the position of the magnetic detection element 2. Conversely, if the object magnet 3 moves leftward (in the −X-direction) in the same range, the magnetic field rotates clockwise at the position of the magnetic detection element 2. In this way, a magnetic flux between the bias magnet 1 and the object magnet 3 has a vector changing in a rotating manner around the position of the magnetic detection element 2 in accordance with the movement of the object magnet 3 in the ±X-directions.

In the range shown in FIGS. 8E, 8F, 8G, and 8H, the magnetic field at the position of the magnetic detection element 2 has a vector changing like a pendulum in the vertical direction in FIGS. 8E, 8F, 8G, and 8H in a range within 180 degrees in accordance with the movement of the object magnet 3 in the ±X-directions.

By detecting these vector changes with the magnetic detection element 2, the position of the object magnet 3 can be detected. As shown in FIG. 9, since the magnetic field direction at the position of the magnetic detection element 2 is changed by approx. 400 degrees in the case of the relative movement of the object magnet 3 within the range shown in FIGS. 8A, 8B, 8C, 8D, 8E, 8F, 8G, and 8H, the stroke range of the object magnet 3 is limited to, for example, a range of X1 or a range of X2 shown in FIG. 9. As a result, since the X-directional movement amount of the object magnet 3 corresponds to the magnetic field direction (angle) in a one-to-one relationship, the movement amount (position) of the object magnet 3 can be detected (uniquely identified) based on the output of the magnetic detection element 2 corresponding to the magnetic field direction.

### Fifth Embodiment

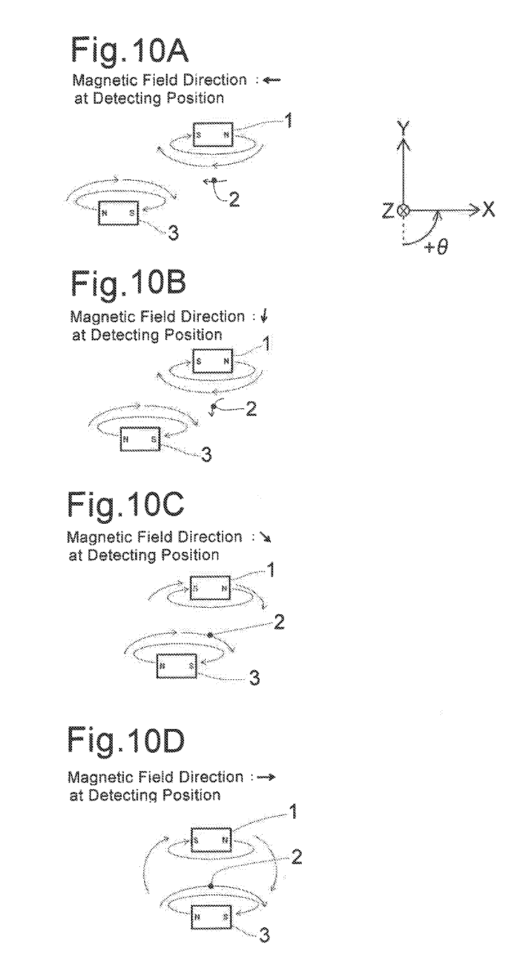

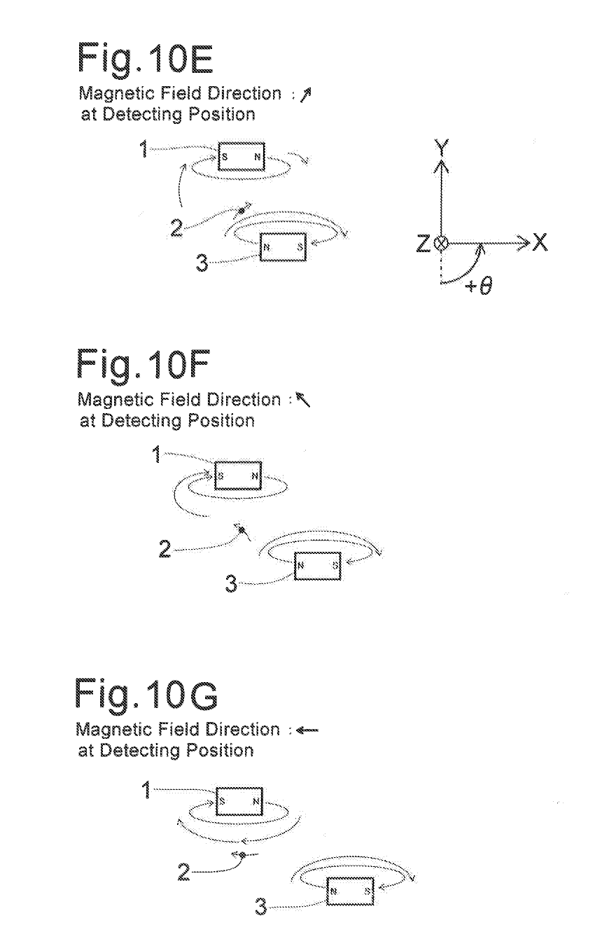

FIGS. 10A, 10B, 10C, 10D, 10E, 10F, and 10G are explanatory views of changes in magnetic lines associated with movement of the object magnet 3 in a magnetic position detection device according to a fifth embodiment of the present invention. In FIGS. 10A, 10B, 10C, 10D, 10E, 10F, and 10G, a mobile object having the object magnet 3 fixed thereto and moving along with the object magnet 3 is not shown. In the magnetic position detection device of this embodiment, unlike the device of the first embodiment shown in FIG. 1 etc., the magnetic pole surfaces of the bias magnet 1 and the magnetic pole surfaces of the object magnet 3 are substantially parallel to each other and substantially perpendicular to the relative movement direction (X-direction) of the object magnet 3 (substantially parallel to the YZ plane). The bias magnet 1 and the object magnet 3 are arranged such that the same poles face each other. Specifically, in the state of FIGS. 10A and 10B, the S-poles face each other and, in the state of FIGS. 10F and 10G, the N-poles face each other. The magnetic detection element 2 is disposed in front of a non-magnetic pole surface of the bias magnet 1 facing toward the object magnet 3. The magnetic detection element 2 is fixedly disposed relative to the bias magnet 1 so as to fix a relative positional relationship with the bias magnet 1. The X-directional position of the magnetic detection element 2 is preferably identical to the X-directional position of the center of the bias magnet 1. Preferably, the magnetic detection element 2 is disposed at a position located closer to the object magnet 3 than the bias magnet 1 when the bias magnet 1 is right in front of the object magnet 3 (come closest to each other). This is because when the bias magnet 1 is right in front of the object magnet 3 as shown in FIG. 10D, the magnetic field generated by the object magnet 3 is made larger than the magnetic field generated by the bias magnet 1 at the position of the magnetic detection element 2. As a result, when the bias magnet 1 is right in front of the object magnet 3, the magnetic field direction at the position of the magnetic detection element 2 can be directed in the +X-direction (rightward) and the magnetic field direction can be rotated by approx. 360 degrees at the position of the magnetic detection element 2 in accordance with the movement of the object magnet 3. In the case of the magnetic detection element 2 capable of detecting two-component detection (XY-component detection), the bias magnet 1, the magnetic detection element 2, and the object magnet 3 preferably have the centers at the Z-directional positions made identical to each other. On the other hand, in the case of the magnetic detection element 2 capable of detecting three-component detection (XYZ-component detection), a two-dimensional position of the object magnet 3 can be detected in the XZ plane, and the object magnet 3 may move in the XZ plane. The movement of the object magnet 3 changes the magnetic field direction at the position of the magnetic detection element 2

As shown in FIGS. 10A, 10B, 10C, 10D, 10E, 10F, and 10G, as the object magnet 3 moves rightward (in the +X-direction), the magnetic field rotates counterclockwise at the position of the magnetic detection element 2. Conversely, if the object magnet 3 moves leftward (in the −X-direction) in the same range, the magnetic field rotates clockwise at the position of the magnetic detection element 2. In this way, a magnetic flux between the bias magnet 1 and the object magnet 3 has a vector changing in a rotating manner around the position of the magnetic detection element 2 in accordance with the movement of the object magnet 3 in the ±X-directions. By detecting this vector change with the magnetic detection element 2, the position of the object magnet 3 can be detected. The magnetic field direction at the position of the magnetic detection element 2 (the angle θ in the counterclockwise direction starting from the −Z-direction) is changed in accordance with the movement of the object magnet 3 as is the case with FIG. 6, and the movement amount (position) of the object magnet 3 can be detected (uniquely identified) based on the output of the magnetic detection element 2 corresponding to the magnetic field direction.

### Sixth Embodiment

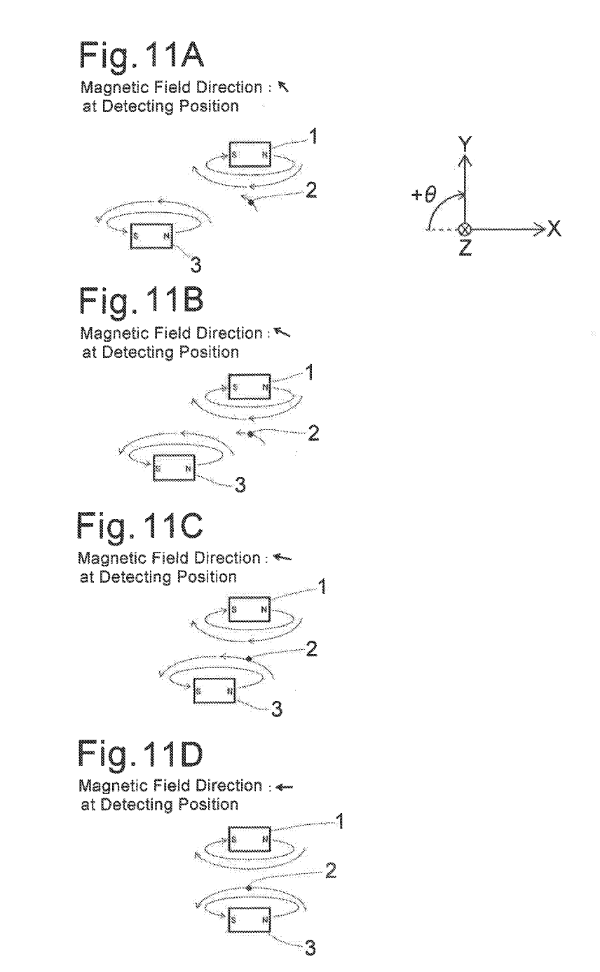

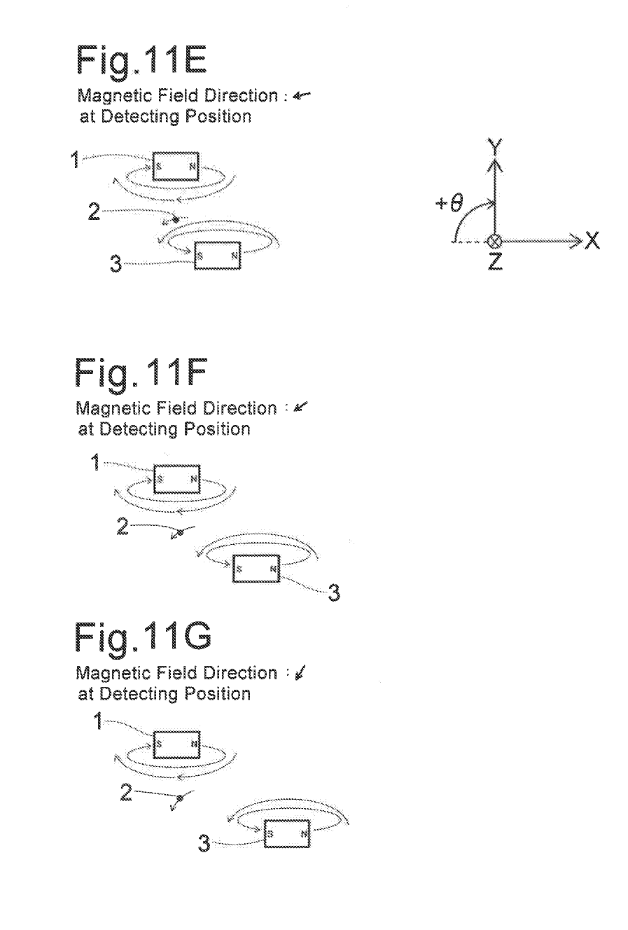

FIGS. 11A, 11B, 11C, 11D, 11E, 11F, and 11G are explanatory views of changes in magnetic lines associated with movement of the object magnet 3 in a magnetic position detection device according to a sixth embodiment of the present invention. In FIGS. 11A, 11B, 11C, 11D, 11E, 11F, and 11G, a mobile object having the object magnet 3 fixed thereto and moving along with the object magnet 3 is not shown. As compared to the device of the fifth embodiment shown in FIGS. 11A, 11B, 11C, 11D, 11E, 11F, and 11G, the magnetic position detection device of this embodiment is different in that the N- and P-poles of the object magnet 3 are inverted, and is identical in terms of the other points. As shown in FIGS. 11A to 11G, as the object magnet 3 moves rightward (in the +X-direction), the magnetic field rotates counterclockwise at the position of the magnetic detection element 2. Conversely, if the object magnet 3 moves leftward (in the −X-direction) in the same range, the magnetic field rotates clockwise at the position of the magnetic detection element 2. In this way, a magnetic flux between the bias magnet 1 and the object magnet 3 has a vector changing like a pendulum in accordance with the movement of the object magnet 3 in the ±X-directions. By detecting this vector change with the magnetic detection element 2, the position of the object magnet 3 can be detected. The magnetic field direction at the position of the magnetic detection element 2 (the angle θ in the counterclockwise direction starting from the −X-direction) is changed in accordance with the movement of the object magnet 3 as is the case with FIG. 2, and the movement amount (position) of the object magnet 3 can be detected (uniquely identified) based on the output of the magnetic detection element 2 corresponding to the magnetic field direction. Also in this embodiment, by using the object magnet 3 having a magnetic force stronger than the bias magnet 1, the stroke range can be widened (the magnetic field direction can be changed by nearly 180 degrees at the position of the magnetic detection element 2 in accordance with the movement of the object magnet 3).

### Seventh Embodiment

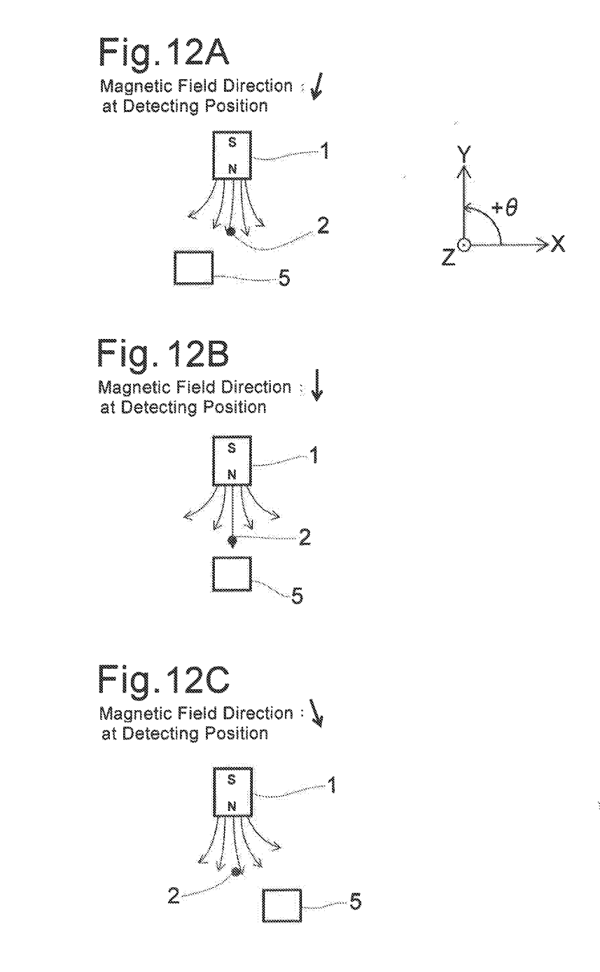

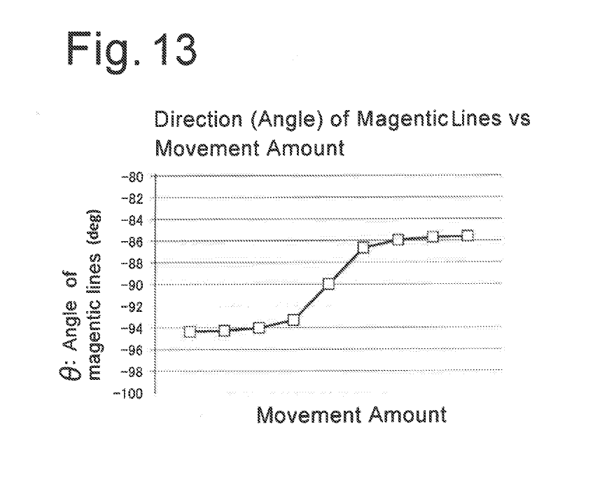

FIGS. 12A, 12B, and 12C are explanatory views of changes in magnetic lines associated with movement of a soft magnetic body 5 in a magnetic position detection device according to a seventh embodiment of the present invention. FIG. 13 is a graph of an example of a relationship between a magnetic field direction (angle) at a position of the magnetic detection element 2 (detection position) and a movement amount of the soft magnetic body 5 in the magnetic position detection device of FIGS. 12A, 12B, and 12C. In FIG. 13, an angle (θ) of the vertical axis is an angle in the counterclockwise direction starting from the +X-direction. As compared to the device of the third embodiment shown in FIG. 5 etc., the magnetic position detection device of this embodiment is different in that the object magnet 3 is replaced with the soft magnetic body 5, and is identical in terms of the other points. The soft magnetic body 5 is fixed to a mobile object not shown and moves in the X-direction as the mobile object moves. As shown in FIG. 13, since the X-directional movement amount of the soft magnetic body 5 corresponds to the magnetic field direction (angle) in a one-to-one relationship, the movement amount (position) of the soft magnetic body 5 and the mobile object can be detected (uniquely identified) based on the output of the magnetic detection element 2 corresponding to the magnetic field direction. According to this embodiment, although the replacement of the object magnet 3 with the soft magnetic body 5 makes the angle variation of the magnetic field acquired at the position of the magnetic detection element 2 smaller so that the stroke range becomes smaller, preferable position detection is enabled even when the detection object is the soft magnetic body 5.

### Eighth Embodiment

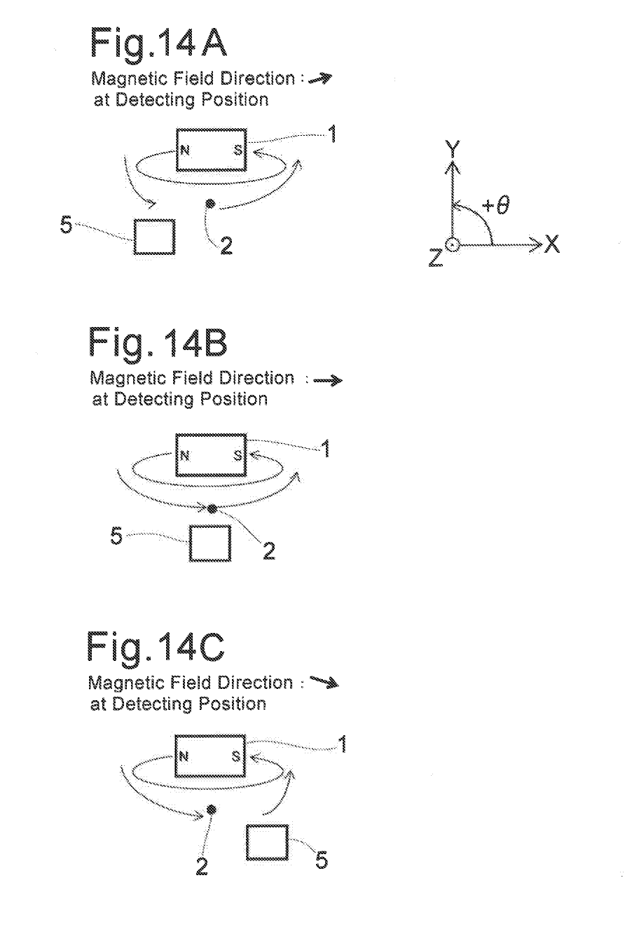

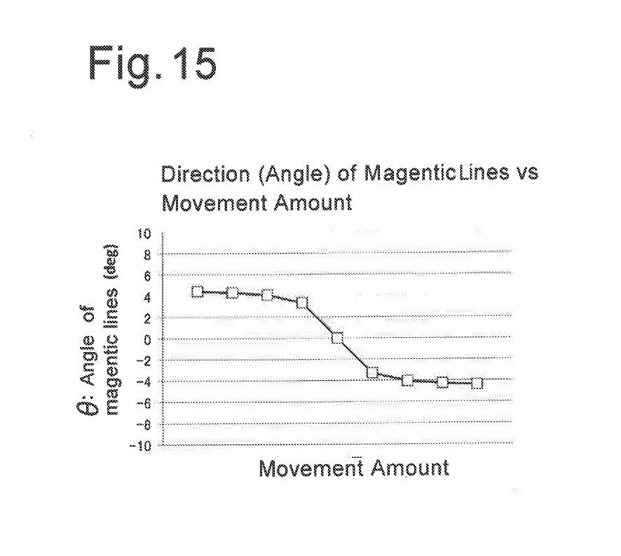

FIGS. 14A, 14B, and 14C are explanatory views of changes in magnetic lines associated with movement of the soft magnetic body 5 in a magnetic position detection device according to an eighth embodiment of the present invention. FIG. 15 is a graph of an example of a relationship between a magnetic field direction (angle) at a position of the magnetic detection element 2 (detection position) and a movement amount of the soft magnetic body 5 in the magnetic position detection device of FIGS. 14A, 14B, and 14C. In FIGS. 14A, 14B, and 14C, an angle (θ) of the vertical axis is an angle in the counterclockwise direction starting from the +X-direction. As compared to the device of the seventh embodiment shown in FIGS. 112A, 12B, and 12C, the magnetic position detection device of this embodiment is different in that the direction of the bias magnet 1 is changed clockwise by 90 degrees, and is identical in terms of the other points. As shown in FIG. 15, since the X-directional movement amount of the soft magnetic body 5 corresponds to the magnetic field direction (angle) in a one-to-one relationship, the movement amount (position) of the soft magnetic body 5 and the mobile object can be detected (uniquely identified) based on the output of the magnetic detection element 2 corresponding to the magnetic field direction. This embodiment can produce the same effects as the seventh embodiment.

Although the present invention has been described by taking the embodiments as examples, it is understood by those skilled in the art that the constituent elements of the embodiments are variously modifiable within the scope of claims. Modification examples will hereinafter be mentioned.

The relative dimensional relationship between the bias magnet 1 and the object magnet 3 or the soft magnetic body 5 and the relative disposition of the magnetic detection element 2 are not limited to the examples described in the embodiments and are arbitrary as long as a magnetic field rotating in accordance with the movement of the object magnet 3 is acquired at the position of the magnetic detection element 2.

In the first to sixth embodiments, the object magnet 3 may be a ring-shaped magnet circling around the mobile object around the X-axis. In this case, in the first embodiment, the cross section acquired by cutting the object magnet 3 along the YZ plane may be more flattened shape than the same cross section of the bias magnet 1. Although the bias magnet 1 and the magnetic detection element 2 are fixed while the object magnet 3 or the soft magnetic body 5 moves in the description of the embodiments, the object magnet 3 or the soft magnetic body 5 may be fixed while the bias magnet 1 and the magnetic detection element 2 move. In other words, a set of the bias magnet 1 and the magnetic detection element 2, and the object magnet 3 or the soft magnetic body 5 may move relative to each other, and which one actually moves is arbitrary.

### EXPLANATIONS OF LETTERS OR NUMERALS

1 Bias magnet
2 Magnetic detection element
3 Object magnet
4 Mobile object
5 Soft magnetic body

1. A magnetic position detection device comprising:
a bias magnet producing a bias magnetic field;
an object magnet producing an object magnetic field; and
a magnetic detection element detecting direction of an applied magnetic field applied to the magnetic detection element, wherein
movement of the object magnet relative to the bias magnet changes magnetic field direction the applied magnetic field that is applied to the magnetic detection element, and,
when the bias magnet and the object magnet come closest to each other, the object magnetic field produced by the object magnet is larger than the bias magnetic field produced by the bias magnet at the magnetic detection element.

2. The magnetic position detection device according to claim 1, wherein
the bias magnet has two magnetic poles of opposite magnetic polarity,
the object magnet has two magnetic poles of opposite magnetic polarity, and
when the bias magnet is directly opposite the object magnet, magnetic poles of the same polarity of the bias magnet and the object magnet face each other.

3. The magnetic position detection device according to claim 1, wherein
the bias magnet has a magnetic pole surface having a first magnetic polarity facing the object magnet,
the object magnet has a magnetic pole surface having a first magnetic polarity facing the bias magnet,
the magnetic pole surfaces of the bias magnet and of the object magnet are substantially parallel to each other and are substantially parallel to direction of the movement of the object magnet relative to the bias magnet, and
the first polarities of the bias magnet and of the object magnet are the same polarity.

4. The magnetic position detection device according to claim 1, wherein
the bias magnet has a magnetic pole surface having a first magnetic polarity facing the object magnet,
the object magnet has a magnetic pole surface having a first magnetic polarity facing the bias magnet,
the magnetic pole surfaces of the bias magnet and of the object magnet are substantially parallel to each other and are substantially parallel to direction of the movement of the object magnet relative to the bias magnet, and
the first polarities of the bias magnet and of the object magnet are different from each other.

5. The magnetic position detection device according to claim 1, wherein
the bias magnet has a magnetic pole surface,
the object magnet has a magnetic pole surface, and
the magnetic pole surfaces of the bias magnet and of the object magnet are substantially parallel to each other and are substantially perpendicular to direction of the movement of the object magnet relative to the bias magnet.

6. The magnetic position detection device according to claim 1, wherein
the bias magnet has a magnetic pole surface,
the object magnet has a magnetic pole surface, and
the magnetic pole surfaces of the bias magnet and of the object magnet are substantially perpendicular to each other.

7. A magnetic position detection device comprising:
a bias magnet;
an object magnet facing the bias magnet such that different magnetic poles of the bias magnet and of the object magnet face each other; and
a magnetic detection element detecting direction of an applied magnetic field that is applied to the magnetic detection element, wherein movement of the object magnet relative to the bias magnet changes magnetic field direction of the applied magnetic field that is applied to at the magnetic detection element.

8. The magnetic position detection device according to claim 7, wherein
the bias magnet has a magnetic pole surface having a length, and
the object magnet has a magnetic pole surface having a length related to the direction of the movement of the object magnet relative to the bias magnet and longer than the length of the magnetic pole surface of the bias magnet.

9. The magnetic position detection device according to claim 1, wherein position of the object magnet relative to the bias magnet is uniquely identifiable.

10. The magnetic position detection device according to claim 1, wherein the magnetic detection element is located at a position that is closer to the object magnet than to the bias magnet when the bias magnet is directly opposite the object magnet.

11. The magnetic position detection device according to claim 1, including only one object magnet.

12. A magnetic position detection device comprising:
a bias magnet;
a soft magnetic body; and
a magnetic detection element detecting direction of an applied magnetic field that is applied to the magnetic detection element, wherein
movement of the soft magnetic body relative to the bias magnet changes magnetic field direction of the applied magnetic field that is applied to the magnetic detection element, and
position of the soft magnetic body relative to the bias magnet is uniquely identifiable.

13. The magnetic position detection device according to claim 7, wherein position of the object magnet relative to the bias magnet is uniquely identifiable.

14. The magnetic position detection device according to claim 7, wherein the magnetic detection element is located at a position that is closer to the object magnet than to the bias magnet when the bias magnet is directly opposite the object magnet.

15. The magnetic position detection device according to claim 7, including only one object magnet.
